(19) United States
(12) Patent Application Publication
(10) Pub. No.: US 2009/0295934 A1
(43) Pub. Date: Dec. 3, 2009

(54) COLOR DEMOSAICKING USING DIRECTION SIMILARITY IN COLOR DIFFERENCE SPACES

(75) Inventors: Oscar Chi Lim Au, Hong Kong (CN); Carman Ka Man Yuk, Hong Kong (CN)

Correspondence Address: TUROCY & WATSON, LLP, 127 Public Square, 57th Floor, Key Tower, CLEVELAND, OH, 44114, US

(73) Assignee: The Hong Kong University of Science and Technology, Hong Kong (CN)

(21) Appl. No.: 12/370,835

(22) Filed: Feb. 13, 2009

Related U.S. Application Data
(60) Provisional application No. 61/056,420, filed on May 27, 2008.

(51) Int. Cl. H04N 5/228; G06K 9/00; G06K 9/32

(52) U.S. Cl. 348/222.1; 382/167; 382/300; 348/E03.012

(57) ABSTRACT

Demosaicking optimizations are provided for still and/or moving image (e.g., video) processes that efficiently generate viewable images. A demosaicking process selects a direction before performing interpolation in order to avoid interpolation across edges and also to minimize color artifacts. The direction to be selected is based on a direction similarity measurement. A digital capture device can includes a system that processes the image data by performing interpolation based on the direction similarity measurement(s) for color difference spaces. The images created based on the directional similarities demonstrate performance gains in peak signal to noise ratio (PSNR).

### CROSS-REFERENCE TO RELATED APPLICATIONS

This application claims priority to U.S. Provisional Application Ser. No. 61/056,420, filed on May 27, 2008, entitled “COLOR DEMOSAICKING USING DIRECTION SIMILARITY IN COLOR DIFFERENCE SPACES”, the entirety of which is incorporated herein by reference.

### TECHNICAL FIELD

The subject disclosure relates to efficient color demosaicking using interpolation processes on color data according to directional similarity measurement(s).

### BACKGROUND

Today, digital cameras are widely used as digital image capture devices, and have generally replaced their analog counterparts in the consumer context. Digital cameras are also widely employed when the capture device is integrated with a device having other functionality. For instance, electronic products of all sorts, such as laptops, mobile phones and pocket PCs, are today equipped with digital image capture devices.

When capturing image data, either video or still images, some conventional systems have implemented three separate charge-coupled devices (CCDs) to capture digital images with red (R), green (G), and blue (B) colors, respectively. Instead of using three CCDs, one CCD can be used with a color filter array (CFA) in order to reduce production cost. A frequently adopted pattern for R, G, B pixelation in digital cameras is referred to as a Bayer CFA 100 as shown in FIG. 1. In the pattern of blocks 102 forming rows and columns, for instance, the G channel provides twice the sampling frequencies over the R and B channels. As such, only one color component is captured at each pixel location. Then, the process of reconstructing full color images with three color R, G, B values at every pixel from such captured images having only one color component at each capture location is called demosaicking or color interpolation.

Bilinear interpolation is a simple demosaicking method, but the reconstructed images are blurred and many color artifacts are introduced. Thus, a variety of conventional demosaicking approaches have been proposed to improve the quality of reconstructed images. For instance, a gradient-corrected bilinear interpolation method has been proposed with a gain parameter to control how much correction is applied. Another interpolation based conventional system proposes a covariance-based adaptation edge-directed interpolation. Based on the property that color differences K_{R} (G−R) and K_{B} (G−B) are usually quite flat within small regions, interpolation has also been performed in the K_{R} and K_{B} spaces as compared to interpolating solely in the R, G and B space. A correction process has also been proposed that applies to interpolation results as an attempt to achieve cost effective demosaicking. Primary-consistent soft-decision color demosaicking (PCSD) has also been proposed to maintain direction consistency during interpolation among colors for each pixel location. PCSD first interpolates the missing G elements vertically and horizontally. Then, the R and B elements are interpolated in vertical and horizontal directions using vertical and horizontal interpolated G values, respectively. However, PCSD implicates a two pass demosaicking operation, which introduces expensive use of computational computing resources.

As mentioned, interpolation has also been performed in the K_{R} and K_{B} color difference spaces as compared to interpolating solely in the R, G and B space. Performing interpolation in color difference spaces K_{R} and K_{B} for demosaicking can achieve reasonable quality in reconstructed images by interpolating K_{R}/K_{B} via averaging the neighboring K_{R}/K_{B}. However, it has been observed that many color artifacts still exist in the reconstructed images, especially at places across image objects where K_{R}/K_{B} varies significantly, such as at edges. Accordingly, an improved demosaicking that is generally artifact free as well as efficient and cost effective to implement.

The above-described deficiencies of current designs for demosaicking operations are merely intended to provide an overview of some of the problems of today's designs, and are not intended to be exhaustive. Other problems with the state of the art and corresponding benefits of the embodiments described herein may become further apparent upon review of the following description.

### SUMMARY

A simplified summary is provided herein to help enable a basic or general understanding of various aspects of exemplary, non-limiting embodiments that follow in the more detailed description and the accompanying drawings. This summary is not intended, however, as an extensive or exhaustive overview. In this regard, the sole purpose of this summary is to present some concepts related to the various exemplary non-limiting embodiments in a simplified form as a prelude to the more detailed description that follows.

Demosaicking optimizations are provided for still and/or moving image (e.g., video) processes that efficiently generate viewable images. In one exemplary non-limiting embodiment, a demosaicking process selects a direction before performing interpolation in order to avoid interpolation across edges and also to minimize color artifacts. The direction to be selected is based on a direction similarity measurement. In another exemplary non-limiting embodiment, a digital capture device is provided that implements a demosaicking process based on the direction similarity measurement(s). The digital capture device, such as a digital camera, may include a data store for storing image data, and a host or other image processing system that processes the image data by performing interpolation based on the direction similarity measurement(s) for color difference spaces. In various embodiments, the images created demonstrate performance gains in peak signal to noise ratio (PSNR).

Various embodiments are described in more detail below.

### BRIEF DESCRIPTION OF THE DRAWINGS

The various optimizations for image demosaicking are further described with reference to the accompanying drawings in which:

FIG. 1 illustrates a Bayer color filter array;

FIG. 2 illustrates a first flow diagram showing an exemplary methodology for achieving demosaicking;

FIG. 3 illustrates a digital image capture device according to an illustrative embodiment for performing demosaicking of image data;

FIG. 4 illustrates a second flow diagram showing an exemplary methodology for achieving demosaicking;

FIG. 5 illustrates a first arrangement of a set of pixels of image data being demosaicked according to an embodiment;

FIG. 6 illustrates a second arrangement of a set of pixels of image data being demosaicked according to an embodiment;

FIG. 7 illustrates a third arrangement of a set of pixels of image data being demosaicked according to an embodiment;

FIG. 8 illustrates a set of images based upon which a variety of conventional algorithms are compared to the demosaicking of embodiments of a direction similarity technique;

FIG. 9 illustrates a comparison of a first zoomed view of a first image from FIG. 8 corresponding to a variety of different demosaicking processes;

FIG. 10 illustrates a comparison of a second zoomed view of a second image from FIG. 8 corresponding to a variety of different demosaicking processes;

FIG. 11 illustrates a comparison of a third zoomed view of a third image from FIG. 8 corresponding to a variety of different demosaicking processes;

FIG. 12 illustrates an overview of a network environment suitable for service by one or more embodiments described herein; and

FIG. 13 illustrates an exemplary, non-limiting device environment in which the demosaicking as described herein may be employed.

### DETAILED DESCRIPTION

### Overview

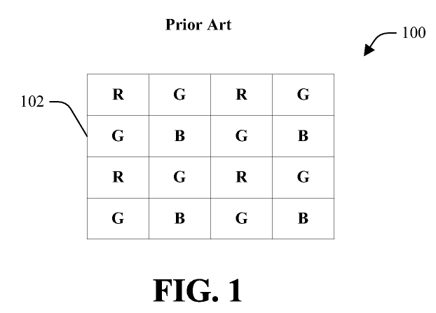

As mentioned, a frequently adopted pattern in digital cameras is the Bayer CFA pattern 100 as shown in FIG. 1. In the pattern, the G channel provides twice the sampling frequencies over the R and B channels. As such, only one color component is captured at every pixel and the process of reconstructing full color images (with three colors available at each pixel) from such partial capturing of images (sampling) is called demosaicking or color interpolation. In various non-limiting embodiments, color demosaicking processes are described that use a measurement of direction similarity in color difference spaces to inform the interpolation processes.

For notational understanding, in the following description, R, G and B are original color values obtained by a CCD while R′, G′ and B′ are the interpolated values resulting from demosaicking. The interpolated values are typically within 0 and 255. K_{R} and K_{B} are color differences (G−R) and (G−B) respectively. Symbols v, w, x, y and z of Rᵥ, G_{w}, Bₓ, K_{Ry} and K_{Bz} are indices that denote the pixel location in the corresponding Figures. Furthermore, any superscript of a color difference denotes its interpolation direction.

As an overview of embodiments that follow, interpolation is performed in the K_{R} and K_{B} color difference spaces instead of solely the R, G and B space based on the observation that the K_{R} and K_{B} spaces are usually flat within small regions. Advantageously, after obtaining estimation of K_{R} and K_{B} throughout the image, R, G and B channels can be obtained by mere addition or subtraction allowing implementation costs to remain low.

### Demosaicking Based on Directional Similarity

As mentioned, demosaicking optimizations are provided for still image and/or video processes that generate viewable images in a cost effective manner. In one aspect that reduces color artifacts, a demosaicking process selects direction before performing interpolation in order to avoid interpolation across edges, basing the direction to be selected on a direction similarity measurement. In another exemplary non-limiting embodiment, a digital camera that implements the demosaicking process includes a data store for storing image data, and an image processing system that processes the image data by performing interpolation based on the direction similarity measurement in color difference spaces.

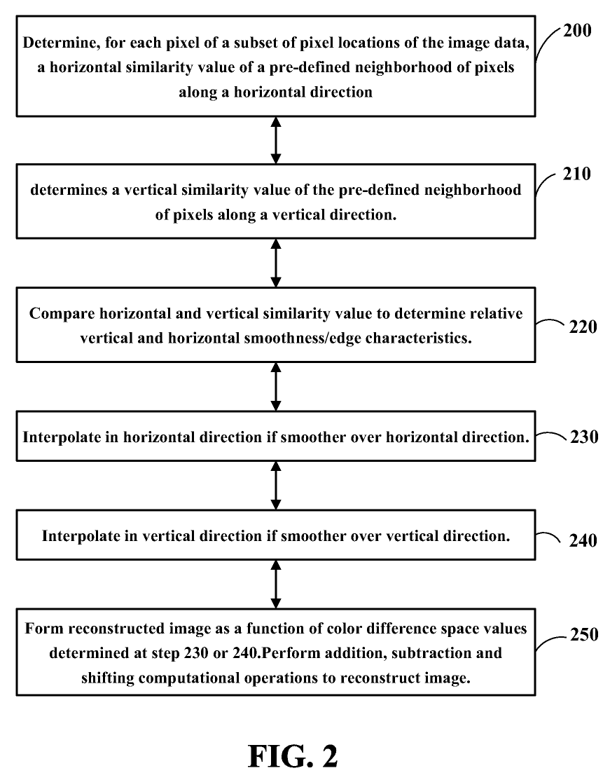

In one embodiment, as shown in FIG. 2, at 200, a demosaicking process for image capture data determines, for each pixel of a subset of pixel locations of the image data, a horizontal similarity value of a pre-defined neighborhood of pixels along a horizontal direction from the given pixel. At 210, the process also determines a vertical similarity value of the pre-defined neighborhood of pixels along a vertical direction from the given pixel. Next, at 220, the values are compared, and at 230, if the comparing indicates an edge characteristic in the horizontal direction, interpolation is performed in the horizontal direction from the given pixel to estimate a first color difference space value for the given pixel. Alternatively, at 240, if the comparing of the values indicates an edge characteristic in the vertical direction, interpolation is performed in the vertical direction from the given pixel to estimate a second color difference space value for the given pixel. Next, at 250, a reconstructed image is formed as a function of the first color difference space value when the edge characteristic is in the horizontal direction and as a function of the second color difference space value when the edge characteristic is in the vertical direction.

In one non-limiting aspect, performing the compare operation first advantageously enables only one interpolation operation to be performed saving time and storage over techniques that perform alternative interpolations and compare interpolation results. In addition, as shown at 250, generating the reconstructed image can be performed using only addition, subtraction and shifting computational operations, which are fast and efficient computations.

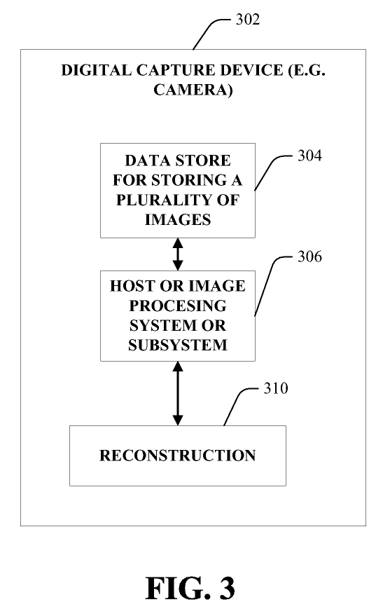

In another embodiment, as shown in FIG. 3, a digital image capture device 302 includes a data store 304 for storing images and an image processing system 306 that determines, for each pixel of image data to be demosaicked, a color difference space value K_{R} representing a color difference of green minus red at the given pixel location of the image data and a color difference space value K_{B} representing a color difference of green minus blue at the given pixel location of the image data. In this regard, for each pixel location of at least a subset of pixels of the image data, prior to determining color difference space value K_{R} and color difference space value K_{B}, the image processing system 306 compares at least one measurement of horizontal similarity of local pixels with at least one measurement of vertical similarity of local pixels, to determine whether interpolating is to occur vertically or horizontally relative to the given pixel location.

In this regard, the color difference space values K_{R} and color difference space value K_{B} are computed by the image processing system 306 for each red, green and blue pixel of captured image data having one color component per image data location, e.g., Bayer CFA image data. Then, using addition, subtraction or shifting operations, a reconstruction component 308 reconstructs the image data from the captured image data based on the color difference space values computed by the image processing system 306 for each pixel of the image data.

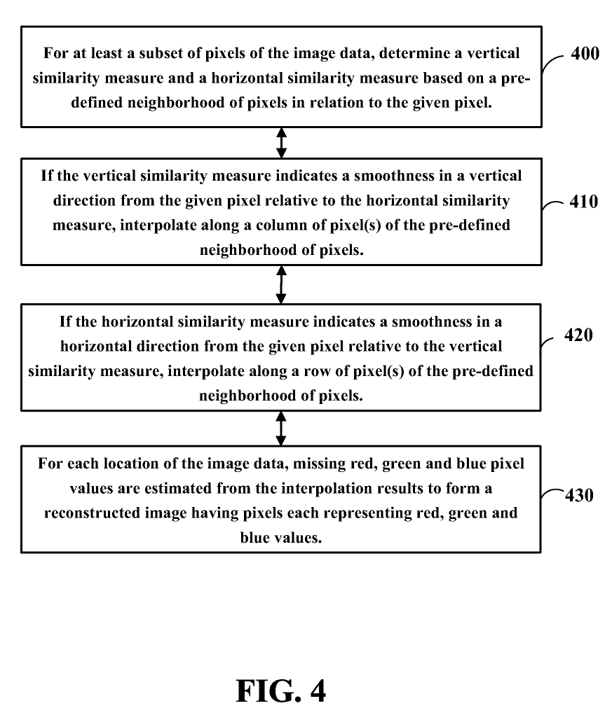

In another non-limiting embodiment shown in the flow diagram of FIG. 4, a method for demosaicking image data having red, green and blue pixel values at respective red, green and blue capture locations of the image data is provided. At 400, for at least a subset of pixels of the image data, a vertical similarity measure and a horizontal similarity measure are determined based on a pre-defined neighborhood of pixels in relation to the given pixel.

Next, at 410, if the vertical similarity measure indicates a smoothness in a vertical direction from the given pixel relative to the horizontal similarity measure, interpolation is performed along a column of at least two pixels of the pre-defined neighborhood of pixels. Alternatively, at 420, if the horizontal similarity measure indicates a smoothness in a horizontal direction from the given pixel relative to the vertical similarity measure, interpolation is performed along a row of at least two pixels of the pre-defined neighborhood of pixels. At 430, for each location of the image data, missing red, green and blue pixel values are estimated to form a reconstructed image having pixels each representing red, green and blue values.

In one non-limiting implementation, color difference space value K_{R} representing color difference green minus red at each red pixel location of the image data and color difference space value K_{B} representing color difference green minus blue at each blue pixel location of the image data are each determined. Then, color difference space value K_{R} at each blue pixel location of the image data and color difference space value K_{B} at each red pixel location of the image data are each determined based on a locus of diagonal neighbors. The method then determines color difference space values K_{R} and K_{B} at each green pixel location of the image data based on another comparison of vertical and horizontal similarity metrics predicated on estimates for neighboring values of the color difference spaces at corresponding red and blue pixel locations, which are horizontal or vertical neighbors of the given green pixel location, depending on the result of the comparing.

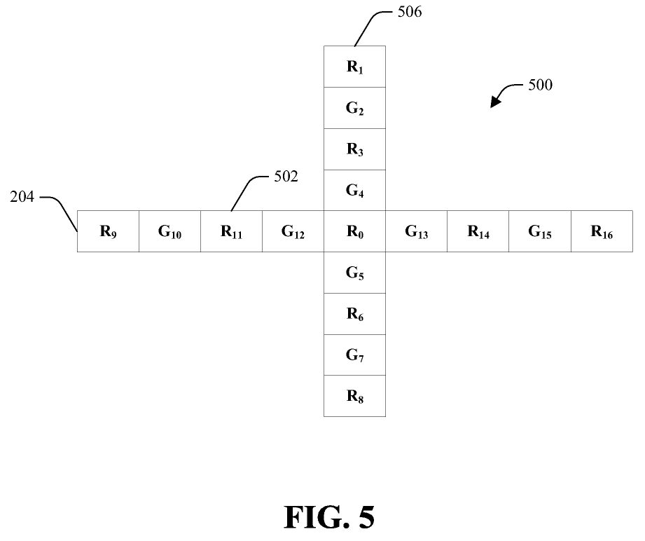

In more detail, in one embodiment, interpolation of K_{R}/K_{B} at R/B pixel locations is performed. K_{R}/K_{B} at R/B is interpolated in either a vertical direction or horizontal direction by averaging K_{R}/K_{B} of the corresponding vertical or horizontal neighbors. In this regard, FIG. 5 illustrates the case 500 of interpolation K_{R} at an R pixel (R₀), wherein a pattern of neighbors 502 includes a row 504 and column 506. If K_{R} is interpolated vertically at the R0 location, K_{RU} is estimated vertically, as in Eqn. 1:

$$\begin{matrix}{K}_{R 0}^{V} = \frac{{K}_{R 4} + {K}_{R 5}}{2} = \frac{( {G}_{4} - {\tilde{R}}_{4} ) + ( {G}_{5} - {\tilde{R}}_{5} )}{2} \\ = \frac{( {G}_{4} - \frac{{R}_{3} + {R}_{0}}{2} ) + ( {G}_{5} - \frac{{R}_{6} + {R}_{0}}{2} )}{2}\end{matrix} \qquad Eqn . 1$$

In Eqn. 1, since \tilde{R}₄ and \tilde{R}₅ do not exist at the moment of performing interpolation, they are approximated by averaging neighboring R values. K_{R0}^{H} is estimated in a similar way along the horizontal direction as in Eqn. 2:

$${K}_{R 0}^{H} = \frac{( {G}_{12} - \frac{{R}_{11} + {R}_{0}}{2} ) + ( {G}_{13} - \frac{{R}_{14} + {R}_{0}}{2} )}{2} \qquad Eqn . 2$$

With the assumption that K_{R}/K_{B} is smooth along an edge, the direction for interpolation is selected based on similarity between the nearest vertical and horizontal estimated K_{R}/K_{B} neighbors. That is, for instance, selection of direction for interpolation of G₀ at R₀ is based on measurement of vertical (V₁) and horizontal (H₁) similarity. V₁ and H₁ are calculated according to Eqns. 3 and 4 as follows:

V₁=|K_{R0}^{V}−K_{R3}^{V}|+|K_{R0}^{V}−K_{R6}^{V}| Eqn. 3

H₁=|K_{R0}^{H}−K_{R11}^{H}|+|K_{R0}^{H}−K_{R14}^{H}| Eqn. 4

Substituting R and G into K_{R}^{V} and K_{R}^{H}, Eqns. 3 and 4 can be simplified to Eqns. 5 and 6:

$$\begin{matrix}{V}_{1} = \frac{1}{2} \vert \begin{matrix}( {G}_{2} - {G}_{5} ) + \\ \frac{1}{2} ( - {R}_{1} - {R}_{3} + {R}_{0} + {R}_{6} )\end{matrix} \vert + \frac{1}{2} \vert \begin{matrix}( {G}_{4} - {G}_{7} ) + \\ \frac{1}{2} ( - {R}_{3} - {R}_{0} + {R}_{6} + {R}_{8} )\end{matrix} \vert & Eqn . 5 \\ {H}_{1} = \frac{1}{2} \vert \begin{matrix}( {G}_{10} - {G}_{13} ) + \\ \frac{1}{2} ( - {R}_{9} - {R}_{11} + {R}_{0} + {R}_{14} )\end{matrix} \vert + \frac{1}{2} \vert \begin{matrix}( {G}_{12} - {G}_{15} ) + \\ \frac{1}{2} ( - {R}_{11} - {R}_{0} + {R}_{14} + {R}_{16} )\end{matrix} \vert & Eqn . 6\end{matrix}$$

If V₁<H₁, then K_{R} is smoother along the vertical direction than horizontal direction. In such case, it is more likely that R₀ is along a vertical structure than a horizontal structure, so K_{R0}^{V} at R₀ is selected. Otherwise, selecting K_{R0}^{H} is a better choice. Eqn. 7 summarizes the process for interpolating K_{R0} at R₀:

$${K}_{R 0} = \{ \begin{matrix}{K}_{R 0}^{V} = \frac{1}{2} ( {G}_{4} + {G}_{5} ) - \frac{1}{4} ( {R}_{3} + 2 {R}_{0} + {R}_{6} ) & if {V}_{1} < {H}_{1} \\ {K}_{R 0}^{H} = \frac{1}{2} ( {G}_{12} + {G}_{13} ) - \frac{1}{4} ( {R}_{11} + 2 {R}_{0} + {R}_{14} ) & if {H}_{1} \leq {V}_{1}\end{matrix} \qquad Eqn . 7$$

Estimation of K_{B} at B pixels can be performed in a similar way. After this procedure, K_{R} has been estimated at R pixels and K_{B} has been estimated at B pixels.

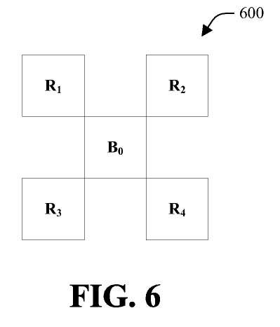

With respect to interpolation of K_{R}/K_{B} at B/R pixel locations, next, the interpolation of K_{R} at B pixel locations is considered. At this point, K_{R} values are available at R pixel locations and none of the R pixels are vertical or horizontal neighbors of the B pixels. Thus, the K_{R} values are used at R pixels at diagonal neighboring locations as shown in the pixel arrangement 600 of FIG. 6, illustrating the diagonal neighboring locations R₁, R₂, R₃ and R₄ with respect to pixel B₀.

In this regard, K_{R0} is computed as the average of the other four K_{R} values, e.g., as in Eqn. 8:

$${K}_{R 0} = \frac{{K}_{R 1} + {K}_{R 2} + {K}_{R 3} + {K}_{R 4}}{4} \qquad Eqn . 8$$

Interpolation of K_{B} at R pixel locations is performed similarly.

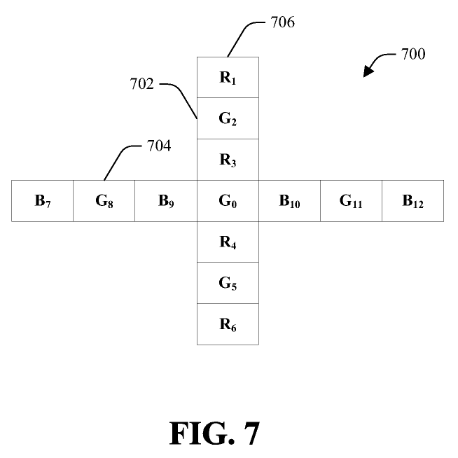

With respect to interpolation of K_{R}/K_{B} at G pixel locations, since the interpolated K_{R}/K_{B} values at B and R pixel locations have been obtained as described above, there are various vertical and horizontal neighbors of K_{R}/K_{B} that are already known. Thus, K_{R}/K_{B} at G pixel locations can be interpolated vertically or horizontally. For example, pixel arrangement 700 of FIG. 7 having pixel pattern 702 having a row 704 and a column 706, is referred to below for Eqns. 9 to 12 for a given G pixel location.

K_{R0}^{V} and K_{R0}^{H} are vertical and horizontal estimate of K_{R0}, as represented by Eqns. 9 and 10:

$$\begin{matrix}{K}_{R 0}^{V} = \frac{{K}_{R 3} + {K}_{R 4}}{2} & Eqn . 9 \\ {K}_{R 0}^{H} = \frac{{K}_{R 9} + {K}_{R 10}}{2} & Eqn . 10\end{matrix}$$

To determine the direction for interpolation in this procedure, the vertical (V₂) and horizontal (H₂) similarities are examined per Eqns. 11 and 12:

$$\begin{matrix}\begin{matrix}{V}_{2} = \vert ( {K}_{R 0}^{V} - {K}_{R 2}^{V} ) \vert + \vert ( {K}_{R 0}^{V} - {K}_{R 5}^{V} ) \vert \\ = \vert \frac{( {K}_{R 3} + {K}_{R 4}}{2} - \frac{( {K}_{R 1} + {K}_{R 3} )}{2} \vert + \\ \vert \frac{( {K}_{R 3} + {K}_{R 4}}{2} - \frac{( {K}_{R 4} + {K}_{R 6} )}{2} \vert \\ = \frac{1}{2} \vert ( {K}_{R 4} - {K}_{R 1} ) \vert + \frac{1}{2} \vert ( {K}_{R 3} - {K}_{R 6} ) \vert\end{matrix} & Eqn . 11 \\ \begin{matrix}{H}_{2} = \vert ( {K}_{R 0}^{H} - {K}_{R 8}^{H} ) \vert + \vert ( {K}_{R 0}^{H} - {K}_{R 11}^{H} ) \vert \\ = \vert \frac{( {K}_{R 9} + {K}_{R 10}}{2} - \frac{( {K}_{R 7} + {K}_{R 9} )}{2} \vert + \\ \vert \frac{( {K}_{R 9} + {K}_{R 10}}{2} - \frac{( {K}_{R 10} + {K}_{R 12} )}{2} \vert \\ = \frac{1}{2} \vert ( {K}_{R 10} - {K}_{R 7} ) \vert + \frac{1}{2} \vert ( {K}_{R 9} - {K}_{R 12} ) \vert\end{matrix} & Eqn . 12\end{matrix}$$

In Eqns. 11 and 12, K_{R0}^{V}, K_{R2}^{V}, K_{R5}^{V}, K_{R0}^{H}, K_{R5}^{H} and K_{R8}^{H} are substituted by averaging of their neighbors K_{R}, such as K_{R0}^{V}, can be substituted by

$$\frac{( {K}_{R 3} + {K}_{R 4} )}{2} .$$

In this regard, K_{R0}^{V} is selected if V₂<H₂ based on the reason that edges along a vertical structure are more likely to occur at G₀, a policy summarized in Eqn. 13 as follows:

$${K}_{R 0} = \{ \begin{matrix}{K}_{R 0}^{V} = \frac{{K}_{R 3} + {K}_{R 4}}{2} & if {V}_{2} < {H}_{2} \\ {K}_{R 0}^{H} = \frac{{K}_{R 9} + {K}_{R 10}}{2} & if {H}_{2} \leq {V}_{2}\end{matrix} \qquad Eqn . 13$$

Additionally, with respect to the computation of R, G and B values from K_{R} and K_{B}, after the above procedures are completed, K_{R} and K_{B} values have been determined for each pixel. To obtain the reconstructed image, the missing elements are computed at different pixel location as follows, using only simple addition or subtraction operations.

At a pixel with an original R value, Eqn. 14 pertains as follows:

G′=K_{R}+R, B′=G′−K_{B} Eqn. 14

At a pixel with an original G value, Eqn. 15 pertains as follows:

R′=G−K_{R}, B′=G−K_{B} Eqn. 15

At a pixel with an original B value, Eqn. 16 pertains as follows:

G′=K_{B}+B, R′=G′−K_{R} Eqn. 16

In this fashion, the reconstructed image is obtained with three color elements at each pixel. The complexity of such color demosaicking is reasonably low because only addition, subtraction and shifting are required for implementation.

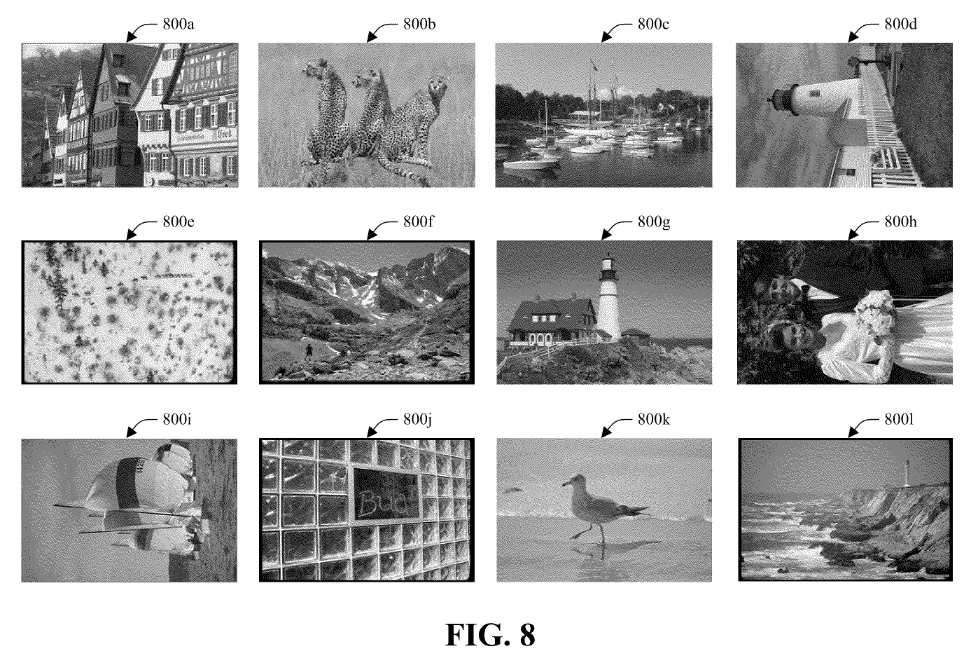

With respect to performance of the above-described demosaicking techniques, Table I below compares the directional similarity techniques described above with conventional bilinear interpolation methods, conventional signal correlation (SC) methods, conventional edge-sensing (ES) methods, and conventional primary consistent soft-decision (PCSD) methods, each being applied to images 800a, 800b, 800c, 800d, 800e, 800f, 800g, 800h, 800i, 800j, 800k and 800l shown in FIG. 8. The images are initially filtered by a Bayer CFA and then the respective interpolation approach is applied to the image data. Peak-signal-to-noise ratio (PSNR) is computed for each primary color, as summarized by Table I below.

TABLE I
Comparison of PSNRs (dB) between Bilinear, SC, ES, PCSD
and Directional

| | | | | | | Directional |
|---|---|---|---|---|---|---|
| Img Ref. | Ch | Bilinear | SC | ES | PCSD | Similarity |
| 800a | R | 22.487 | 30.241 | 30.533 | 32.318 | 34.261 |
| | G | 27.359 | 33.097 | 32.419 | 34.681 | 34.973 |
| | B | 22.743 | 29.793 | 30.412 | 31.605 | 33.294 |
| 800b | R | 27.622 | 36.518 | 35.318 | 36.224 | 37.915 |
| | G | 31.763 | 37.719 | 35.512 | 37.500 | 38.277 |
| | B | 27.856 | 36.457 | 34.936 | 36.391 | 37.522 |
| 800c | R | 25.119 | 31.491 | 31.551 | 31.691 | 33.011 |
| | G | 29.149 | 33.898 | 33.449 | 34.190 | 34.710 |
| | B | 25.168 | 30.948 | 31.574 | 31.209 | 32.738 |
| 800d | R | 27.011 | 34.534 | 35.506 | 37.141 | 38.682 |
| | G | 31.751 | 37.051 | 37.054 | 39.289 | 39.626 |
| | B | 27.141 | 34.347 | 35.305 | 36.977 | 38.333 |
| 800e | R | 27.753 | 34.511 | 34.692 | 35.122 | 36.391 |
| | G | 33.486 | 39.309 | 38.046 | 39.044 | 39.672 |
| | B | 30.122 | 37.619 | 37.755 | 36.856 | 37.870 |
| 800f | R | 24.677 | 32.525 | 31.338 | 32.178 | 33.473 |
| | G | 28.670 | 34.753 | 32.965 | 34.498 | 34.794 |
| | B | 25.266 | 32.588 | 31.793 | 32.234 | 33.216 |
| 800 | R | 27.105 | 33.027 | 32.959 | 33.046 | 34.132 |
| | G | 31.428 | 36.161 | 35.605 | 35.985 | 36.344 |
| | B | 28.308 | 34.096 | 34.679 | 33.741 | 34.851 |
| 800 | R | 28.829 | 35.964 | 35.488 | 35.595 | 36.625 |
| | G | 32.327 | 38.261 | 36.658 | 37.985 | 38.422 |
| | B | 29.503 | 36.797 | 36.307 | 36.049 | 37.002 |
| 800 | R | 31.447 | 38.543 | 38.917 | 40.329 | 41.285 |
| | G | 35.653 | 41.079 | 40.252 | 42.657 | 42.758 |
| | B | 31.504 | 38.279 | 38.440 | 39.947 | 40.641 |
| 800j | R | 26.441 | 34.036 | 35.072 | 36.733 | 37.678 |
| | G | 31.217 | 36.503 | 36.669 | 39.303 | 39.641 |
| | B | 26.075 | 33.152 | 34.450 | 35.857 | 36.709 |
| 800k | R | 36.233 | 40.680 | 42.325 | 42.106 | 42.982 |
| | G | 39.129 | 42.452 | 42.921 | 43.640 | 43.971 |
| | B | 35.209 | 39.462 | 40.993 | 40.825 | 41.666 |
| 800l | R | 27.613 | 34.348 | 33.740 | 34.801 | 35.470 |
| | G | 32.741 | 38.743 | 37.569 | 38.804 | 39.049 |
| | B | 29.093 | 36.187 | 36.273 | 36.495 | 37.334 |
| Average | | 29.306 | 35.699 | 35.541 | 36.474 | 37.370 |

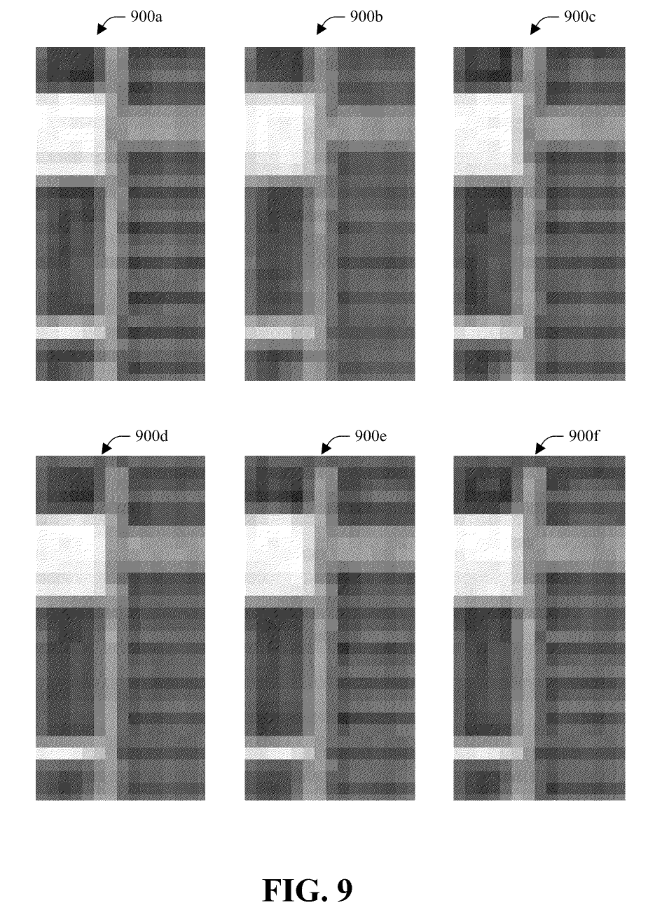

In addition to the quantitative data of Table I, FIGS. 9, 10 and 11 illustrate a comparison of a zoomed views of image 500a, 500c, 500d, respectively, from FIG. 8 corresponding to the visual performance of a variety of different demosaicking processes. Images 900a, 1000a and 1100a of FIGS. 9, 10 and 11, respectively, illustrate the original image data.

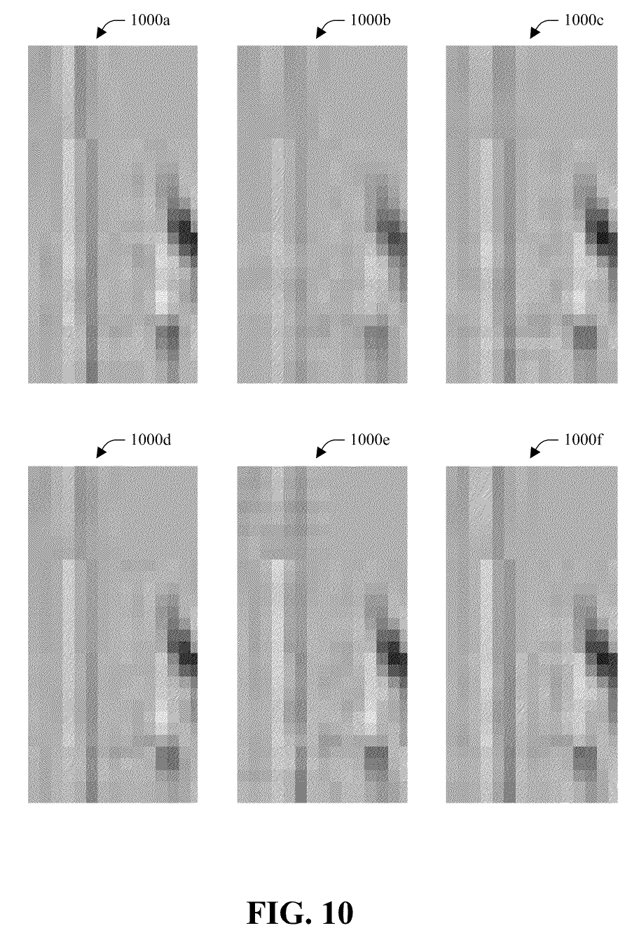

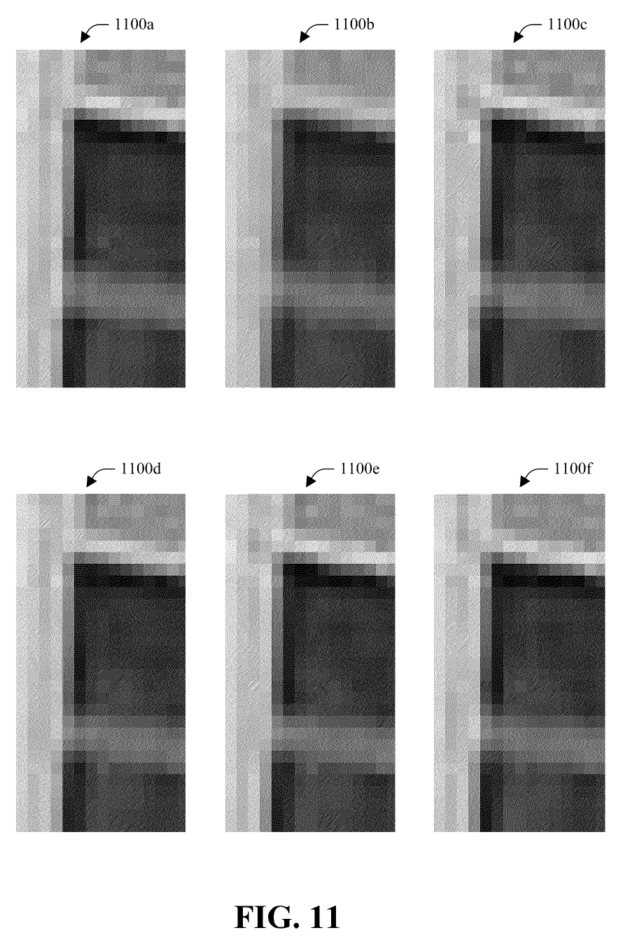

With respect to performance results, as expected, bilinear interpolation is a simple interpolation method, but has poor performance. Its poor objective quality of interpolation results are demonstrated in Table I and zoom-in pictures of poorly reconstructed images are shown in image 900b of FIG. 9, 1000b of FIG. 10 and 1100b of FIG. 11. The approach using SC, as represented in images 900c, 1000c and 1100c, performs interpolation in the K_{R} and K_{B} spaces, but it performs simple neighbor averaging of K_{R} and K_{B} without considering whether they belong to the same object. Color artifacts are usually found at the edge of objects, especially at places with large variation of K_{R}/K_{B}. Conventional ES detects edges and applies adaptive interpolation, but induces many color artifacts in the reconstructed images as can be readily observed from images 900d, 1000d and 1100d of FIGS. 9, 10 and 11, respectively.

Reconstructed images 900e, 1000e and 1100e from the PCSD approach have relatively good visual quality and high average PSNR, but complexity is high because it interpolates all missing colors at each pixel twice and makes decisions about choosing one from the two interpolated results as part of generating the reconstructed signal. Advantageously, the directional similarity techniques described herein has similar quality to PCSD, as evinced by images 900f, 1000f and 1100f, but uses only about half of the memory used for PCSD. This is because PCSD memorizes two interpolated results for each missing color, whereas the techniques described herein predicated on the similarity measurements make a decision before performing the interpolation. Accordingly, two separate interpolated results do not need to be stored with the direction similarity techniques.

Moreover, for similar reasons, the direction similarity techniques consume only about half the time spent by PCSD to compute one missing color because PCSD calculates results twice for each missing color before making decision in contrast to making the decision before performing interpolation, as described herein. As a result, the total average PSNR of reconstructed images applied for the direction similarity techniques described herein is about 8 dB higher than that of bilinear interpolation and 0.9 dB higher than PCSD.

A color demosaicking algorithm thus adaptively selects direction for interpolation. Since color differences are usually smooth along the edge, the direction selection method is based on similarity along the directions in the color difference spaces. The complexity of the method is low because reconstruction need only employ addition, subtraction and shifting. Visual quality of reconstructed images is improved and relatively high PSNR is achieved when compared to conventional demosaicking algorithms.

### Exemplary Computer Networks and Environments

One of ordinary skill in the art can appreciate that the innovation can be implemented in connection with any computer or other client or server device, which can be deployed as part of a computer network, or in a distributed computing environment, connected to any kind of data store. In this regard, the present innovation pertains to any computer system or environment having any number of memory or storage units, and any number of applications and processes occurring across any number of storage units or volumes, which may be used in connection with optimization algorithms and processes performed in accordance with the present innovation. The present innovation may apply to an environment with server computers and client computers deployed in a network environment or a distributed computing environment, having remote or local storage. The present innovation may also be applied to standalone computing devices, having programming language functionality, interpretation and execution capabilities for generating, receiving and transmitting information in connection with remote or local services and processes.

Distributed computing provides sharing of computer resources and services by exchange between computing devices and systems. These resources and services include the exchange of information, cache storage and disk storage for objects, such as files. Distributed computing takes advantage of network connectivity, allowing clients to leverage their collective power to benefit the entire enterprise. In this regard, a variety of devices may have applications, objects or resources that may implicate the optimization algorithms and processes of the innovation.

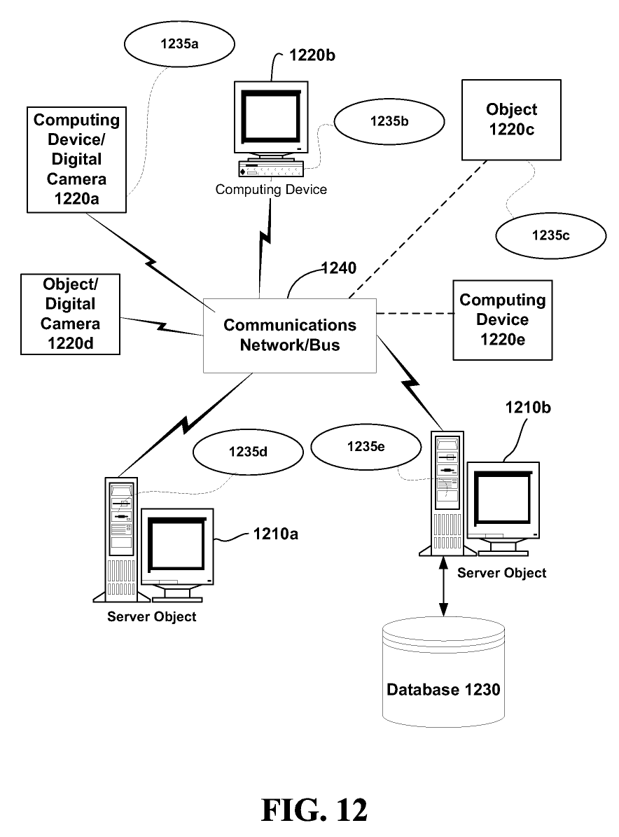

FIG. 12 provides a schematic diagram of an exemplary networked or distributed computing environment. The distributed computing environment comprises computing objects 1210a, 1210b, etc. and computing objects or devices 1220a, 1220b, 1220c, 1220d, 1220e, etc. These objects may comprise programs, methods, data stores, programmable logic, etc. The objects may comprise portions of the same or different devices such as PDAs, audio/video devices, MP3 players, digital cameras, personal computers, etc. Each object can communicate with another object by way of the communications network 1240. This network may itself comprise other computing objects and computing devices that provide services to the system of FIG. 12, and may itself represent multiple interconnected networks. In accordance with an aspect of the innovation, each object 1210a, 1210b, etc. or 1220a, 1220b, 1220c, 1220d, 1220e, etc. may contain an application that might make use of an API, or other object, software, firmware and/or hardware, suitable for use with embodiments described herein.

It can also be appreciated that an object, such as 1220c, may be hosted on another computing device 1210a, 1210b, etc. or 1220a, 1220b, 1220c, 1220d, 1220e, etc. Thus, although the physical environment depicted may show the connected devices as computers, such illustration is merely exemplary and the physical environment may alternatively be depicted or described comprising various digital devices such as PDAs, televisions, MP3 players, etc., any of which may employ a variety of wired and wireless services, software objects such as interfaces, COM objects, and the like.

There are a variety of systems, components, and network configurations that support distributed computing environments. For example, computing systems may be connected together by wired or wireless systems, by local networks or widely distributed networks. Currently, many of the networks are coupled to the Internet, which provides an infrastructure for widely distributed computing and encompasses many different networks. Any of the infrastructures may be used for exemplary communications made incident to optimization algorithms and processes according to the present innovation.

Thus, the network infrastructure enables a host of network topologies such as client/server, peer-to-peer, or hybrid architectures. The “client” is a member of a class or group that uses the services of another class or group to which it is not related. Thus, in computing, a client is a process, i.e., roughly a set of instructions or tasks, that requests a service provided by another program. The client process utilizes the requested service without having to “know” any working details about the other program or the service itself. In a client/server architecture, particularly a networked system, a client is usually a computer that accesses shared network resources provided by another computer, e.g., a server. In the illustration of FIG. 12, as an example, digital cameras/capture devices/computers 1220a, 1220b, 1220c, 1220d, 1220e, etc. can be thought of as clients and computers 1210a, 1210b, etc. can be thought of as servers where servers 1210a, 1210b, etc. maintain the data that is then replicated to client computers 1220a, 1220b, 1220c, 1220d, 1220e, etc., although any computer can be considered a client, a server, or both, depending on the circumstances. Any of these computing devices may be processing data or requesting services or tasks that may implicate the optimization algorithms and processes in accordance with the innovation.

A server is typically a remote computer system accessible over a remote or local network, such as the Internet or wireless network infrastructures. The client process may be active in a first computer system, and the server process may be active in a second computer system, communicating with one another over a communications medium, thus providing distributed functionality and allowing multiple clients to take advantage of the information-gathering capabilities of the server. Any software objects utilized pursuant to the optimization algorithms and processes of the innovation may be distributed across multiple computing devices or objects.

Client(s) and server(s) communicate with one another utilizing the functionality provided by protocol layer(s). For example, HyperText Transfer Protocol (HTTP) is a common protocol that is used in conjunction with the World Wide Web (WWW), or “the Web.” Typically, a computer network address such as an Internet Protocol (IP) address or other reference such as a Universal Resource Locator (URL) can be used to identify the server or client computers to each other. The network address can be referred to as a URL address. Communication can be provided over a communications medium, e.g., client(s) and server(s) may be coupled to one another via TCP/IP connection(s) for high-capacity communication.

Thus, FIG. 12 illustrates an exemplary networked or distributed environment, with server(s) in communication with client computer (s) via a network/bus, in which the present innovation may be employed. In more detail, a number of servers 1210a, 1210b, etc. are interconnected via a communications network/bus 1240, which may be a LAN, WAN, intranet, GSM network, the Internet, etc., with a number of client or remote computing devices/digital cameras 1220a, 1220b, 1220c, 1220d, 1220e, etc., such as a portable computer, handheld computer, thin client, networked appliance, or other device, such as a VCR, TV, light, heater and the like in accordance with the present innovation, i.e., anywhere where demosaicking of image data is desirable. It is thus contemplated that the present innovation may apply to any computing device in connection with which it is desirable to communicate data over a network or standalone device that does not connect to anything else.

In a network environment in which the communications network/bus 1240 is the Internet, for example, the servers 1210a, 1210b, etc. can be Web servers with which the clients 1220a, 1220b, 1220c, 1220d, 1220e, etc. communicate via any of a number of known protocols such as HTTP. Servers 1210a, 1210b, etc. may also serve as clients 1220a, 1220b, 1220c, 1220d, 1220e, etc., as may be characteristic of a distributed computing environment.

As mentioned, communications may be wired or wireless, or a combination, where appropriate. Client devices 1220a, 1220b, 1220c, 1220d, 1220e, etc. may or may not communicate via communications network/bus 14, and may have independent communications associated therewith. For example, in the case of a TV or VCR, there may or may not be a networked aspect to the control thereof. Each client computer 1220a, 1220b, 1220c, 1220d, 1220e, etc. and server computer 1210a, 1210b, etc. may be equipped with various application program modules or objects 1235a, 1235b, 1235c, etc. and with connections or access to various types of storage elements or objects, across which files or data streams may be stored or to which portion(s) of files or data streams may be downloaded, transmitted or migrated. Any one or more of computers 1210a, 1210b, 1220a, 1220b, 1220c, 1220d, 1220e, etc. may be responsible for the maintenance and updating of a database 1230 or other storage element, such as a database or memory 1230 for storing data processed or saved according to the innovation. Thus, the present innovation can be utilized in a computer network environment having client computers 1220a, 1220b, 1220c, 1220d, 1220e, etc. that can access and interact with a computer network/bus 1240 and server computers 1210a, 1210b, etc. that may interact with client computers 1220a, 1220b, 1220c, 1220d, 1220e, etc. and other like devices, and databases 1230.

### Exemplary Digital Image Capture Device/Computing Device

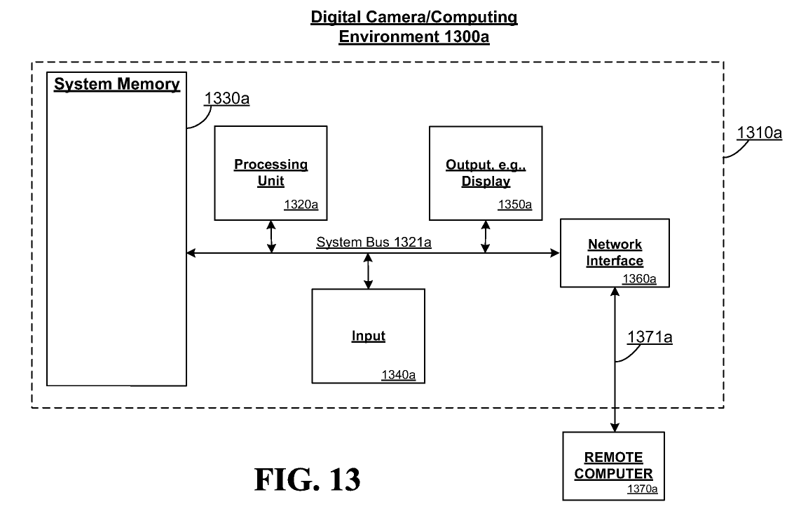

As mentioned, the innovation applies to any device wherein it may be desirable to demosaick image data. It should be understood, therefore, that handheld, portable and other computing devices and computing objects of all kinds are contemplated for use in connection with the present innovation, i.e., anywhere that a device may demosaick image data or otherwise receive, process or store image data for demosaicking. Accordingly, the below general purpose remote computer described below in FIG. 13 is but one example, and the present innovation may be implemented with any client having network/bus interoperability and interaction. Thus, the present innovation may be implemented in an environment of networked hosted services in which very little or minimal client resources are implicated, e.g., a networked environment in which the client device serves merely as an interface to the network/bus, such as an object placed in an appliance.

Although not required, embodiments can partly be implemented via an operating system, for use by a developer of services for a device or object, and/or included within application software that operates in connection with the component(s) of the innovation. Software may be described in the general context of computer executable instructions, such as program modules, being executed by one or more computers, such as client workstations, servers or other devices. Those skilled in the art will appreciate that embodiments may be practiced with other computer system configurations and protocols.

FIG. 13 thus illustrates an example of a suitable digital camera/computing system environment 1300a in which the innovation may be implemented, although as made clear above, the computing system environment 1300a is only one example of a suitable computing environment for a media device and is not intended to suggest any limitation as to the scope of use or functionality of the innovation. Neither should the computing environment 1300a be interpreted as having any dependency or requirement relating to any one or combination of components illustrated in the exemplary operating environment 1300a.

With reference to FIG. 13, an exemplary remote device for implementing any of the embodiments described herein includes a general purpose computing device in the form of a computer 1310a. Components of computer 1310a may include, but are not limited to, a processing unit 1320a, a system memory 1330a, and a system bus 1321a that couples various system components including the system memory to the processing unit 1320a. The system bus 1321a may be any of several types of bus structures including a memory bus or memory controller, a peripheral bus, and a local bus using any of a variety of bus architectures.

Computer 1310a typically includes a variety of computer readable media. Computer readable media can be any available media that can be accessed by computer 1310a. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 1310a. Communication media typically embodies computer readable instructions, data structures, program modules or other data in a modulated data signal such as a carrier wave or other transport mechanism and includes any information delivery media.

The system memory 1330a may include computer storage media in the form of volatile and/or nonvolatile memory such as read only memory (ROM) and/or random access memory (RAM). A basic input/output system (BIOS), containing the basic routines that help to transfer information between elements within computer 1310a, such as during start-up, may be stored in memory 1330a. Memory 1330a typically also contains data and/or program modules that are immediately accessible to and/or presently being operated on by processing unit 1320a. By way of example, and not limitation, memory 1330a may also include an operating system, application programs, other program modules, and program data.

The computer 1310a may also include other removable/non-removable, volatile/nonvolatile computer storage media. For example, computer 1310a could include a hard disk drive that reads from or writes to non-removable, nonvolatile magnetic media, a magnetic disk drive that reads from or writes to a removable, nonvolatile magnetic disk, and/or an optical disk drive that reads from or writes to a removable, nonvolatile optical disk, such as a CD-ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM and the like. A hard disk drive is typically connected to the system bus 1321a through a non-removable memory interface such as an interface, and a magnetic disk drive or optical disk drive is typically connected to the system bus 1321a by a removable memory interface, such as an interface.

A user may enter commands and information into the computer 1310a through input devices such as a keyboard and pointing device, commonly referred to as a mouse, trackball or touch pad. Other input devices may include a microphone, joystick, game pad, satellite dish, scanner, or the like. These and other input devices are often connected to the processing unit 1320a through user input 1340a and associated interface(s) that are coupled to the system bus 1321a, but may be connected by other interface and bus structures, such as a parallel port, game port or a universal serial bus (USB). A graphics subsystem may also be connected to the system bus 1321a. A monitor or other type of display device is also connected to the system bus 1321a via an interface, such as output interface 1350a, which may in turn communicate with video memory. In addition to a monitor, computers may also include other peripheral output devices such as speakers and a printer, which may be connected through output interface 1350a.

The computer 1310a may operate in a networked or distributed environment using logical connections to one or more other remote computers, such as remote computer 1370a, which may in turn have media capabilities different from device 1310a. The remote computer 1370a may be a personal computer, a digital camera, a server, a router, a network PC, a peer device or other common network node, or any other remote media consumption or transmission device, and may include any or all of the elements described above relative to the computer 1310a. The logical connections depicted in FIG. 13 include a network 1371a, such local area network (LAN) or a wide area network (WAN), but may also include other networks/buses. Such networking environments are commonplace in homes, offices, enterprise-wide computer networks, intranets and the Internet.

When used in a LAN networking environment, the computer 1310a is connected to the LAN 1371a through a network interface or adapter. When used in a WAN networking environment, the computer 1310a typically includes a communications component, such as a modem, or other means for establishing communications over the WAN, such as the Internet. A communications component, such as a modem, which may be internal or external, may be connected to the system bus 1321a via the user input interface of input 1340a, or other appropriate mechanism. In a networked environment, program modules depicted relative to the computer 1310a, or portions thereof, may be stored in a remote memory storage device. It will be appreciated that the network connections shown and described are exemplary and other means of establishing a communications link between the computers may be used.

While the present innovation has been described in connection with the preferred embodiments of the various Figures, it is to be understood that other similar embodiments may be used or modifications and additions may be made to the described embodiment for performing the same function of the present innovation without deviating therefrom. For example, one skilled in the art will recognize that the present innovation as described in the present application may apply to any environment, whether wired or wireless, and may be applied to any number of such devices connected via a communications network and interacting across the network. Therefore, the present innovation should not be limited to any single embodiment, but rather should be construed in breadth and scope in accordance with the appended claims.

The word “exemplary” is used herein to mean serving as an example, instance, or illustration. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, for the avoidance of doubt, such terms are intended to be inclusive in a manner similar to the term “comprising” as an open transition word without precluding any additional or other elements.

Various implementations of the innovation described herein may have aspects that are wholly in hardware, partly in hardware and partly in software, as well as in software. As used herein, the terms “component,” “system” and the like are likewise intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers.

Thus, the methods and apparatus of the present innovation, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the innovation. In the case of program code execution on programmable computers, the computing device generally includes a processor, a storage medium readable by the processor (including volatile and non-volatile memory and/or storage elements), at least one input device, and at least one output device.

Furthermore, the disclosed subject matter may be implemented as a system, method, apparatus, or article of manufacture using standard programming and/or engineering techniques to produce software, firmware, hardware, or any combination thereof to control a computer or processor based device to implement aspects detailed herein. The terms “article of manufacture”, “computer program product” or similar terms, where used herein, are intended to encompass a computer program accessible from any computer-readable device, carrier, or media. For example, computer readable media can include but are not limited to digital cameras, magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick). Additionally, it is known that a carrier wave can be employed to carry computer-readable electronic data such as those used in transmitting and receiving electronic mail or in accessing a network such as the Internet or a local area network (LAN).

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components, e.g., according to a hierarchical arrangement. Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

In view of the exemplary systems described supra, methodologies that may be implemented in accordance with the disclosed subject matter will be better appreciated with reference to the various flow diagrams. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Where non-sequential, or branched, flow is illustrated via flowchart, it can be appreciated that various other branches, flow paths, and orders of the blocks, may be implemented which achieve the same or a similar result. Moreover, not all illustrated blocks may be required to implement the methodologies described hereinafter.

Furthermore, as will be appreciated various portions of the disclosed systems above and methods below may include or consist of artificial intelligence or knowledge or rule based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent.

While the present innovation has been described in connection with the preferred embodiments of the various figures, it is to be understood that other similar embodiments may be used or modifications and additions may be made to the described embodiment for performing the same function of the present innovation without deviating therefrom.

While exemplary embodiments may refer to a context of particular programming language constructs, specifications or standards, the innovation is not so limited, but rather may be implemented in any language to perform the optimization algorithms and processes. Still further, the present innovation may be implemented in or across a plurality of processing chips or devices, and storage may similarly be effected across a plurality of devices. Therefore, the present innovation should not be limited to any single embodiment, but rather should be construed in breadth and scope in accordance with the appended claims.

An Appendix is provided that includes additional details and context for the above described embodiments. For the avoidance of doubt, the Appendix shall be considered independent disclosure to the embodiments described above. In this regard, the inclusion of the Appendix shall be considered in no way limiting on the above-described embodiments, but shall instead merely represent supplemental disclosure.

What is claimed is:

1. A method for demosaicking image data, comprising:
for each pixel of at least a subset of pixel locations of the image data, determining a first value corresponding to a horizontal similarity of a pre-defined neighborhood of pixels along a horizontal direction from the given pixel and determining a second value corresponding to a vertical similarity of the pre-defined neighborhood of pixels along a vertical direction from the given pixel;
comparing the first and second values; and
if the comparing of the first and second values indicates an edge characteristic in the horizontal direction, interpolating in the horizontal direction from the given pixel to estimate a first color difference space value for the given pixel.

2. The method of claim 1, further comprising:
generating reconstructed image data as a function of the first color difference space value when the edge characteristic is in the horizontal direction.

3. The method of claim 1, further comprising:
if the comparing of the first and second values indicates an edge characteristic in the vertical direction, interpolating in the vertical direction from the given pixel to estimate a second color difference space value for the given pixel.

4. The method of claim 3, further comprising:
generating reconstructed image data as a function of the second color difference space value when the edge characteristic is in the vertical direction.

5. The method of claim 1, further comprising:
generating reconstructed image data as a limited function of addition, subtraction and shifting computational operations.

6. A digital image capture device, comprising:
at least one data store for storing images; and
an image processing system that determines, for each pixel of image data to be demosaicked, a color difference space value K_{R} representing a color difference of green minus red at the given pixel location of the image data and a color difference space value K_{B} representing a color difference of green minus blue at the given pixel location of the image data,
wherein, for each pixel location of at least a subset of pixels of the image data, prior to determining color difference space value K_{R} and color difference space value K_{B}, at least one measurement of horizontal similarity of local pixels is compared with at least one measurement of vertical similarity of local pixels, to determine whether interpolating occurs vertically or horizontally relative to the given pixel location.

7. The device of claim 6, wherein the color difference space values K_{R} and color difference space value K_{B} are computed by the image processing system for each red, green and blue pixel of captured image data having one color component per image data location.

8. The device of claim 7, wherein the color difference space values K_{R} and color difference space value K_{B} are computed by the image processing system for each red, green and blue pixel of Bayer color filter array (CFA) image data.

9. The device of claim 7, wherein the image processing system reconstructs reconstructed image data based on the color difference space values computed by the image processing system for each pixel of the image data.

10. The device of claim 7, wherein the image processing system reconstructs reconstructed image data based on addition, subtraction or shifting operations only.

11. A method for demosaicking image data, comprising:
receiving image data comprising red, green and blue pixel values for demosaicking at respective red, green and blue locations of the image data;
for at least a subset of pixels of the image data, determining a vertical similarity measure and a horizontal similarity measure based on a pre-defined neighborhood of pixels in relation to the given pixel, and
interpolating along a column of at least two pixels of the pre-defined neighborhood of pixels where the vertical similarity measure indicates a smoothness in a vertical direction from the given pixel relative to the horizontal similarity measure.

12. The method of claim 11, further comprising:
interpolating along a row of at least two pixels of the pre-defined neighborhood of pixels where the horizontal similarity measure indicates a smoothness in a horizontal direction from the given pixel relative to the vertical similarity measure.

13. The method of claim 11, further comprising:
for each location of the image data, estimating missing red, green and blue pixel values to form a reconstructed image having pixels each representing red, green and blue values.

14. The method of claim 11, further including:
determining a color difference space value K_{R} representing color difference green minus red at each red pixel location of the image data; and
determining a color difference space value K_{B} representing color difference green minus blue at each blue pixel location of the image data.

15. The method of claim 11, further including:
determining a color difference space value K_{R} representing color difference green minus red at each blue pixel location of the image data; and
determining a color difference space value K_{B} representing color difference green minus blue at each red pixel location of the image data.

16. The method of claim 15, wherein the determining includes determining a color difference space value K_{R} at each blue pixel location of the image data based on diagonal neighboring locations relative to given blue pixel location.

17. The method of claim 11, further including:
determining a color difference space value K_{R} representing color difference green minus red at each green pixel location of the image data; and
determining a color difference space value K_{B} representing color difference green minus blue at each green pixel location of the image data.

18. The method of claim 17, wherein the determining of the color difference space values K_{R} and K_{B} at each green pixel location includes determining as a function of estimated values for K_{R} and K_{B} at red pixel locations and blue pixel locations.

19. The method of claim 18, wherein the determining of the color difference space values K_{R} and K_{B} at each green pixel location includes determining as a function of estimated values for K_{R} and K_{B} at red pixel locations and blue pixel locations that are horizontal and vertical neighbors of the given green pixel location.

20. The method of claim 11, further comprising:
for at least a second subset of pixels of the image data, determining a second vertical similarity measure and a second horizontal similarity measure based on a second pre-defined neighborhood of pixels in relation to the given pixel, and
interpolating along a column of at least two pixels of the second pre-defined neighborhood of pixels where the second vertical similarity measure indicates a smoothness in a vertical direction from the given pixel relative to the second horizontal similarity measure; and
interpolating along a row of at least two pixels of the second pre-defined neighborhood of pixels where the second horizontal similarity measure indicates a smoothness in a horizontal direction from the given pixel relative to the second vertical similarity measure.

21. A computer readable medium comprising computer executable instructions for performing the method of claim 1.
